(19) United States
(12) Patent Application Publication
(10) Pub. No.: US 2007/0222741 A1
(43) Pub. Date: Sep. 27, 2007

(54) LIQUID CRYSTAL DISPLAY APPARATUS AND BACKLIGHT UNIT USED IN LIQUID CRYSTAL DISPLAY APPARATUS

(75) Inventor: Hideki Itaya, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD TECHNOLOGIES, LTD., Kawasaki (JP)

(21) Appl. No.: 11/689,277

(22) Filed: Mar. 21, 2007

(30) Foreign Application Priority Data
Mar. 22, 2006 (JP) 2006-078018

(51) Int. Cl. G09G 3/36

(52) U.S. Cl. 345/102

(57) ABSTRACT

A display apparatus provides an improved control accuracy of the brightness and the chromaticity. The liquid crystal display apparatus has a liquid crystal panel and a backlight unit for applying diffused light to the liquid crystal panel in a form of a sheet. The backlight unit has a light source, a light guide plate for converting light emitted from the light source into a sheetlike beam of light, an optical sheet for converting light emitted from the light guide plate into condensed light or diffused light, and an optical sensor unit for detecting a portion of light from the light guide plate and converting the detected light into an electric signal. The backlight unit also has a case housing the light source, the light guide plate, the optical sheet, and the optical sensor unit. The optical sensor unit is fixed to an area that is inside of the light guide plate and exerts no influence on display.

This application claims priority to prior Japanese patent application JP2006-078018, the disclosure of which is incorporated herein by reference.

### BACKGROUND OF THE INVENTION

1. Field of the Invention

The present invention relates to a liquid crystal display apparatus, and more particularly to a liquid crystal display apparatus having a function of controlling a brightness or a chromaticity with an optical sensor and a backlight unit used in such a liquid crystal display apparatus.

2. Description of the Related Art

A liquid crystal display apparatus employs technology of controlling a light source for adjusting a brightness or a chromaticity of light applied to a liquid crystal panel to a desired level. For example, Japanese laid-open patent publication No. 2004-199968 (Patent Document 1) discloses such a liquid crystal display apparatus.

According to Patent Document 1, light is applied from a sheetlike light source device to an entire surface of a liquid crystal panel. The sheetlike light source device includes an LED light source and a light guide plate for converting light emitted from the LED light source into a sheetlike beam of light and directing the beam of light to the liquid crystal panel. Some of light in the light guide plate is monitored with an optical sensor provided on a side surface of the light guide plate. The LED light source is controlled according to the level of the detected light. In order to detect light emitted from the side surface of the light guide plate with a sensor, it is necessary to fix the sensor and a light shield member enclosing the sensor to some portions in the apparatus. However, Patent Document 1 fails to disclose how to fix the optical sensor.

Heretofore, there has been known a liquid crystal display apparatus in which an optical sensor for detecting light emitted from a light guide plate is fixed onto a side surface of a case for a backlight unit as shown in FIG. 1.

The liquid crystal display apparatus shown in FIG. 1 includes a light source 401 of two or more colors such as red, green, and blue, a liquid crystal panel 402 for displaying images, one or more light guide plates 403 for converting light emitted from the light source 401 into a sheetlike beam of light and guiding the beam of light into the liquid crystal panel 402, a reflector plate 404 for reflecting light emitted from the light guide plate 403 to an opposite side of the liquid crystal panel 402 and directing the light to the liquid crystal panel 402 through the light guide plate 403, and an optical sheet 405 for condensing or diffusing light from the light guide plate 403 and directing the light to the liquid crystal panel 402.

Furthermore, the liquid crystal display apparatus includes an inner case 415 and an outer case 416 disposed on a rear side of the reflector plate 404. The inner case 415 serves as a case for a backlight, and the outer case 416 serves as a monitor frame. The aforementioned light source 401, liquid crystal panel 402, light guide plate 403, reflector plate 404, and optical sheet 405 are housed in the inner case 415. The inner case 415 is housed in the outer case 416. The inner case 415 has a recessed portion 415a formed on the right side surface thereof. The recessed portion 415a serves to receive a projecting portion 403a provided on the right side surface of the light guide plate 403 for positioning. An optical sensor 406 is provided on a portion of a wall of the recessed portion 415a. Thus, the liquid crystal display apparatus has a backlight unit in which the reflector plate 404, the light guide plate 403, the optical sheet 405, and the light source 401 are housed in the outer case 416. In this backlight unit, the optical sensor 406, which is provided on the wall of the recessed portion 415a of the inner case 415, receives light emitted from a side surface of the projecting portion 403a of the light guide plate 403. The optical sensor 406 is housed in a case 407 for shielding the optical sensor 406 from external light. Thus, the optical sensor 406 and the case 407 form an optical sensor unit.

The light source 401 is controlled by an operation part 408 and a backlight controller 409. The operation part 408 is operable to compare a detection level of light received by the optical sensor 406 with a signal level that the display apparatus requires for reproducing a desired brightness and chromaticity of an image to be displayed and to perform calculation. The backlight controller 409 is operable to control the intensity of the light source 401 for each color based on the calculated information of the operation part 408. The optical sensor 406 is fixed onto the inner case 415, together with the case 407 for shielding the optical sensor 406 from external light, by a screw or the like.

However, the optical sensor 406, which is housed in the light shield case 407, is fixed to the inner case 415, which serves as a case for the backlight unit. The positional relationship between the optical sensor 406 and the light guide plate is changed by movement of the light guide plate 403, movement of the light shield case 407, which houses the optical sensor 406, and expansion or shrinkage due to temperature. Accordingly, the distance between a light-emitting surface and a light-receiving portion of the optical sensor 406 is varied so as to cause a variation in optical loss. Thus, a difference is produced between output information of the optical sensor 406 and information stored in the operation part 408, so that values controlled by the backlight controller 409 differ from proper values. Therefore, the brightness and the chromaticity of an image displayed on the liquid crystal panel 402 become different from desired settings.

### SUMMARY OF THE INVENTION

It is, therefore, an object of the present invention to provide a liquid crystal display apparatus which has a function of controlling a brightness or a chromaticity with an optical sensor, can reduce a variation of a detection level of a light-receiving portion in the optical sensor due to mechanical factors, and can improve a control accuracy of the brightness and the chromaticity.

Another object of the present invention is to provide a backlight unit used in such a liquid crystal display apparatus.

According to the present invention, there is provided a backlight unit comprising a light source, a light guide plate for converting light emitted from the light source into a sheetlike beam of light, an optical sensor unit for detecting a portion of light from the light guide plate and converting the detected light into an electric signal, and a case housing the light source, the light guide plate, and the optical sensor unit, wherein said optical sensor unit is fixed to an area that is inside of said light guide plate and exerts no influence on display.

According to another aspect of the invention, there is provided a liquid crystal display apparatus comprising a liquid crystal panel and a backlight unit for applying diffused light to said liquid crystal panel in a form of a sheet. The backlight unit includes a light source, a light guide plate for converting light emitted from the light source into a sheetlike beam of light, an optical sensor unit for detecting a portion of light from the light guide plate and converting the detected light into an electric signal, and a case housing the light source, the light guide plate, and the optical sensor unit, wherein the optical sensor unit is fixed to an area that is inside of said light guide plate and exerts no substantial influence on display.

It is preferred that the optical sensor unit in the backlight unit is embedded in a hollowed portion of a side surface of the light guide plate.

Preferably, the optical sensor unit includes a light-receiving element, a light-diffusible resin having a light transmittance and being disposed on a front surface of the light-receiving element, and a light shield resin for molding the light-diffusible resin and the light-receiving element to fix the optical sensor unit so as to expose a surface of the light-diffusible resin into which light is introduced.

The optical sensor unit may include a color filter disposed between the light-receiving element and the light-diffusible resin.

The light source may include LEDs of two or more colors, or a cold cathode fluorescent lamp.

It is preferred that the liquid crystal display apparatus includes operation means for comparing a signal level detected by the optical sensor unit with a reference level to generate control information, and backlight control means for controlling an intensity of the light source based on the control information from the operation means.

The liquid crystal display apparatus may be controlled by a field sequential color technique.

According to the present invention, an optical sensor is provided in a side surface of a light guide plate so as to directly detect light within the light guide plate. Accordingly, a positional relationship between the light guide plate and the optical sensor is integrally fixed. Specifically, the positional relationship between the light guide plate and the optical sensor is unlikely to be subjected to an external influence. When a supply current to a light source is controlled by a detection level sensed with this configuration, it is possible to reduce a variation of a detection level due to changes of the positional relationship.

Furthermore, according to an embodiment of the present invention, resin containing a dispersing agent is disposed on a light-receiving portion. Resin for light shield is disposed around the sensor and fixed together with the optical sensor and a color filter. With this configuration, it is possible to prevent light having no directivity and biased light from being introduced into the light-receiving portion of the sensor. Moreover, it is also possible to reduce a detection deviation due to entry of external light from side surfaces of the sensor or the like. Accordingly, a level of noise can be reduced so as to provide a signal level required for detection. As a result, the control of the liquid crystal display apparatus is facilitated.

### BRIEF DESCRIPTION OF THE DRAWINGS

FIG. 1 is an exploded perspective view showing a conventional liquid crystal display apparatus;

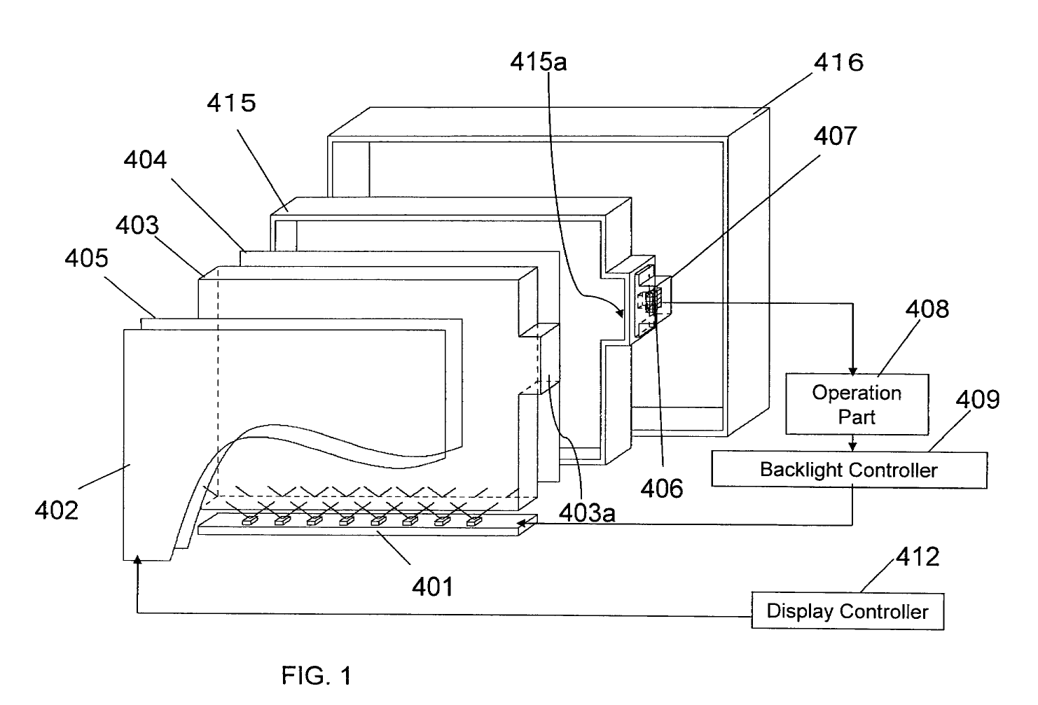

FIG. 2 is an exploded perspective view showing a liquid crystal display apparatus according to a first embodiment of the present invention;

FIG. 3 is an enlarged cross-sectional view of a sensor unit in the liquid crystal display apparatus according to the first embodiment of the present invention; and

FIG. 4 is an exploded perspective view showing a liquid crystal display apparatus according to a second embodiment of the present invention.

### DETAILED DESCRIPTION OF THE PREFERRED EMBODIMENTS

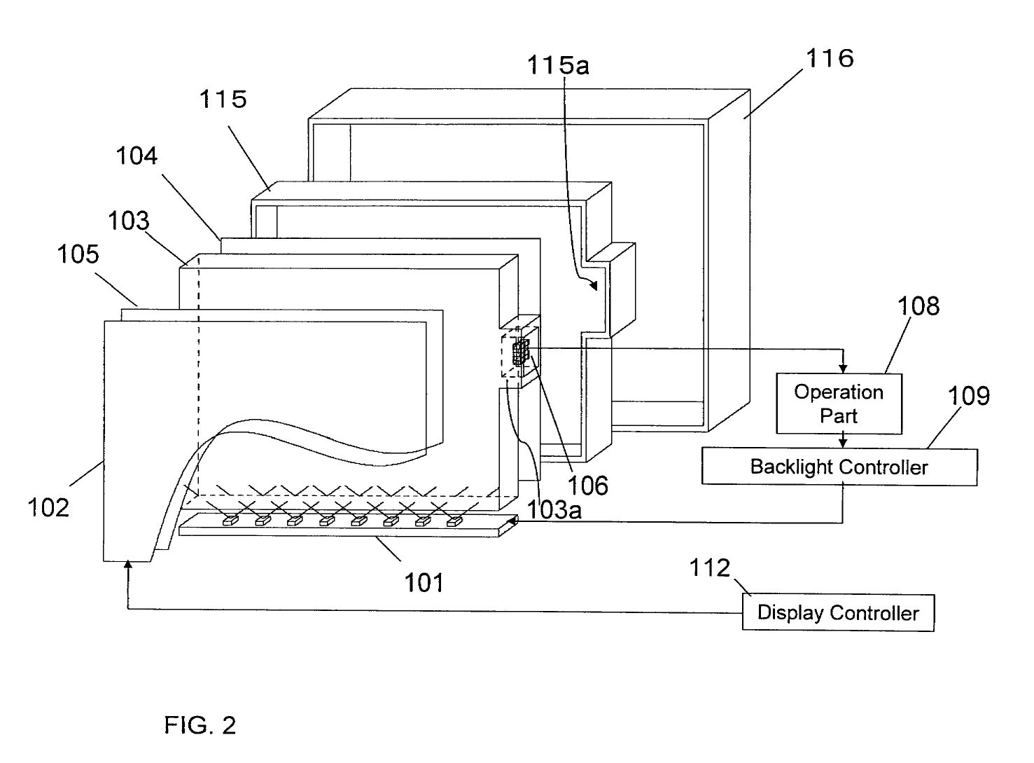

Embodiments of the present invention will be described below with reference to FIGS. 2 to 4.

FIG. 2 is an exploded perspective view schematically showing a liquid crystal display apparatus according to a first embodiment of the present invention.

As shown in FIG. 2, the liquid crystal display apparatus includes a liquid crystal panel 102, a LED light source 101, an optical sheet 105, a light guide plate 103, and a reflector plate 104. The liquid crystal display apparatus also includes an inner case 115, which serves as a case for a backlight unit. The liquid crystal display apparatus includes an outer case 116, which serves as a monitor frame housing the backlight unit and the liquid crystal panel 102. The light guide plate 103 is formed of a transparent material, such as acrylic resin, having substantially a rectangular parallelepiped shape. The LED light source 101 is disposed on a lower surface of the light guide plate 103. Light emitted from the LED light source 101 is introduced into the light guide plate 103 from the lower surface of the light guide plate 103, reflected within the light guide plate 103, and converted into light directed to a plane of the light guide plate 103. The optical sheet 105 is disposed on a surface of the light guide plate 103 near the liquid crystal panel 102. The optical sheet 105 serves to condense or diffuse light from the light guide plate 103 so as to emit the light to the liquid crystal panel 102. The reflector plate 104 is disposed on an opposite surface of the light guide plate 103 to the optical sheet 105. The reflector plate 104 serves to reflect light emitted from the light guide plate 103 toward the reflector plate 104 so as to direct the light toward the light guide plate 103 for the purpose of effective use of light.

The light guide plate 103 has a projecting portion 103a provided on the right surface thereof. The projecting portion 103a is hollowed out with a suitable size so that an optical sensor unit 120 is embedded in the hollowed portion on the side surface of the light guide plate 103. Portions around the optical sensor unit 120 are fixed by resin. The projecting portion 103a serves to position the light guide plate 103 with respect to the inner case 115. The projecting portion 103a is fitted into a recessed portion 115a provided on an inner surface of the inner case 115 and thus housed in the inner case 115.

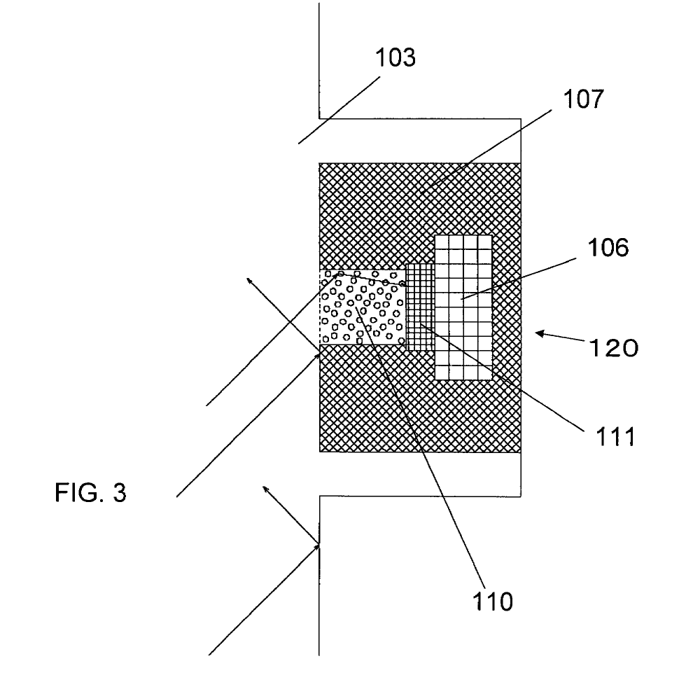

FIG. 3 shows a structure for receiving the optical sensor unit 120 within the light guide plate 103. FIG. 3 is a cross-sectional view taken along a plane that is parallel to a surface of the light guide plate 103 and passes through the center of an optical sensor 106. In FIG. 3, the optical sensor unit 120 includes an optical sensor 106 such as a photodiode, a color filter 111 disposed on a light-receiving surface of the optical sensor 106, and a diffusion resin member 110 disposed on a foreside of the color filter 111. The diffusion resin member 110 has light-transmittable and light-diffusible properties. The optical sensor 106, the color filter 111, and the diffusion resin member 110 are embedded in light shield resin 107 except a front side (left side) of the diffusion resin member 110. The optical sensor unit 120 is received in the hollowed portion of the projecting portion 103a of the light guide plate 103 and fixed by an adhesive or the like.

In FIG. 3, an optical path in which light is introduced through the diffusion resin member 110 into the color filter 111 in the optical sensor unit 120 is illustrated together with part of an optical path in which light passing through the light guide plate 103 is reflected on the right surface of the light guide plate 103 and an optical path in which light passing through the light guide plate 103 is reflected on a surface of the light shield resin 107.

The optical sensor 106 has three light-receiving portions so as to receive light of red, green, and blue, respectively. The color filter 111, which is disposed on a front side of the optical sensor 106, has color areas for red, green, and blue which corresponds to the light-receiving portions of the optical sensor 106 to introduce each color component to the corresponding light-receiving portion.

Referring back to FIG. 2, the LED light source 101 has an array of LEDs capable of emitting light of red, green, and blue, respectively. When the red LEDs, the green LEDs, and the blue LEDs are lighted at the same time, these colors are mixed in the light guide plate 103 so as to provide white light as backlight. White light may not be necessary depending upon the application of the liquid crystal display apparatus. In such a case, only one or two types of colors may be used in the LEDs.

The inner case 115 houses the reflector plate 104, the LED light source 101, the light guide plate 103 with the optical sensor unit 120, and the optical sheet 105, thereby forming a backlight unit. The backlight unit and the liquid crystal panel 102 are housed in the outer case 116 as the monitor frame to thus form a liquid crystal display apparatus. In this embodiment, a usual panel, which performs colorization with color filters, is used as the liquid crystal panel 102.

Light received by the optical sensor 106 in the optical sensor unit 120 is converted into an electric signal and transmitted to an operation part 108. The operation part 108 compares the detection level of light received by the optical sensor 106 with a signal level that the display apparatus requires for reproducing a desired brightness and chromaticity of an image to be displayed and performs calculation. A backlight controller 109 controls the intensity of the LED light source 101 for each color based on the calculated information of the operation part 108. The operation part 108 stores information on detection of the sensor which corresponds to the brightness and chromaticity of an image displayed on the liquid crystal panel 102 which is obtained by the light source 101 controlled with a desired output. The backlight controller 109 performs a feedback control so that the detection signal in the optical sensor 106 accords with the information stored in the operation part 108. Thus, an image having constant brightness and chromaticity can be displayed on the liquid crystal panel 102. The reference numeral 112 denotes a display controller for controlling display of the liquid crystal panel 102.

As described above, in the present embodiment, the optical sensor is embedded in the side surface of the light guide plate so as to directly detect light within the light guide plate. Accordingly, a positional relationship between the light guide plate and the optical sensor is integrally fixed. Specifically, the positional relationship between the light guide plate and the optical sensor is unlikely to be subjected to an external influence. When a supply current to the light source is controlled by a detection level sensed with this configuration, it is possible to reduce a variation of a detection level due to changes of the positional relationship.

The resin containing a dispersing agent is disposed on the light-receiving portion. The resin for light shield is disposed around the sensor and fixed together with the optical sensor and the color filter. With this configuration, it is possible to prevent light having no directivity and biased light from being introduced into the light-receiving portion of the sensor. Furthermore, it is also possible to reduce a variation of a detection level due to entry of external light from side surfaces of the sensor or the like. Accordingly, a level of noise can be reduced so as to provide a signal level required for detection. As a result, the control of the liquid crystal display apparatus is facilitated.

Furthermore, the optical sensor unit is formed in the projecting portion, which is provided on the side surface of the light guide portion for positioning with respect to the recessed portion of the outer case. Accordingly, it is possible to prevent a shadow of the optical sensor unit from appearing on the display area.

In the above embodiment, the LED light source is used in the backlight unit. However, a cold cathode fluorescent lamp (CCFL) may be used in the backlight unit.

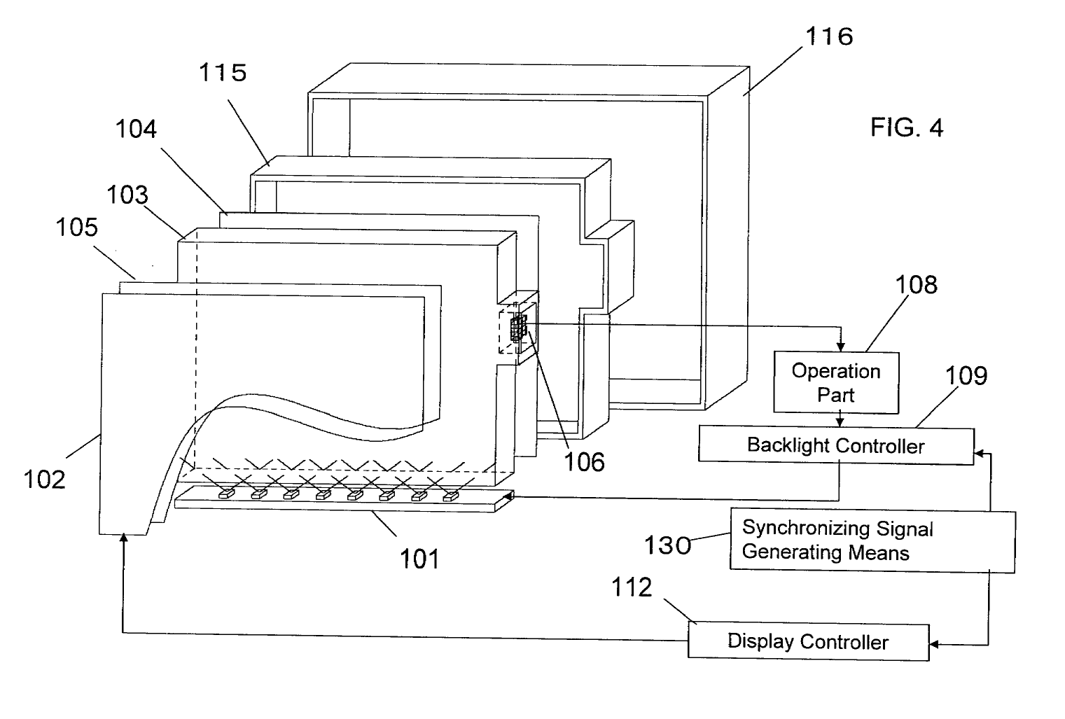

FIG. 4 is an exploded perspective view schematically showing a liquid crystal display apparatus according to a second embodiment of the present invention.

The second embodiment shown in FIG. 4 differs from the first embodiment shown in FIG. 2 in that a synchronizing signal circuit 130 is provided in the liquid crystal display apparatus. Components including a liquid crystal panel, a light guide plate, an LED light source, an optical sheet, a reflector plate, a light guide plate, and an optical sensor unit provided integrally on the light guide plate are the same as those in the aforementioned first embodiment and are thus omitted from the following description, which is focused on differences from the first embodiment.

The liquid crystal display apparatus in the present embodiment employs field sequential color (FSC) technique in which each color of red, green and blue displayed on a liquid crystal panel is synchronized with each color of light emission from red, green and blue light sources. Accordingly, the liquid crystal display apparatus in the present embodiment uses a liquid crystal panel different from a usual panel, which performs colorization with color filters. In the FSC method, backlight of the three primary colors of red, green, and blue is sequentially applied without use of color filters. An image having only a color component synchronized with each color is displayed on pixels by a control circuit. Thus, the three colors of red, green, and blue are temporally mixed with each other so as to obtain a colored image. Accordingly, the synchronizing signal generation means 130 is needed for a display controller 112 and a backlight controller 109 to synchronize lighting of red, green, and blue colors in the backlight light source with fields for each signal of colors to be displayed on the liquid crystal panel.

In the FSC method of the present embodiment, the optical sensor unit may have one light-receiving area or may have no color filter provided therein. Since red LEDs, green LEDs, and blue LEDs are sequentially lighted in the LED light source, one light-receiving area is sufficient for the optical sensor unit. In fact, an operation part 108 is required to perform correction of the chromatic sensitivity of the optical sensor which corresponds to each color of red, green, and blue.

Although certain preferred embodiments of the present invention have been shown and described in detail, the present invention is not limited to these illustrated embodiments. It should be understood that various changes and modifications may be made therein without departing from the sprit of the present invention.

What is claimed is:

1. A backlight unit comprising a light source, a light guide plate for converting light emitted from said light source into a sheetlike beam of light, an optical sensor unit for detecting a portion of light from said light guide plate and converting the detected light into an electric signal, and a case housing said light source, said light guide plate, and said optical sensor unit, wherein:
said optical sensor unit is fixed to an area that is inside of said light guide plate and exerts no influence on display substantially.

2. A liquid crystal display apparatus comprising a liquid crystal panel and a backlight unit for applying diffused light to said liquid crystal panel in a form of a sheet, wherein:
said backlight unit includes a light source, a light guide plate for converting light emitted from said light source into a sheetlike beam of light, an optical sensor unit for detecting a portion of light from said light guide plate and converting the detected light into an electric signal, and a case housing said light source, said light guide plate, and said optical sensor unit, and
said optical sensor unit is fixed to an area that is inside of said light guide plate and exerts no influence on display.

3. The liquid crystal display apparatus as recited in claim 2, wherein said optical sensor unit in said backlight unit is embedded in a hollowed portion of a side surface of said light guide plate.

4. The liquid crystal display apparatus as recited in claim 3, wherein said optical sensor unit includes a light-receiving element, a light-diffusible resin having a light transmittance and being disposed on a front surface of said light-receiving element, and a light shield resin for molding said light-diffusible resin and said light-receiving element to fix said optical sensor unit so as to expose a surface of said light-diffusible resin into which light is introduced.

5. The liquid crystal display apparatus as recited in claim 4, wherein said optical sensor unit includes a color filter disposed between said light-receiving element and said light-diffusible resin.

6. The liquid crystal display apparatus as recited in claim 5, wherein said light source includes LEDs of two or more colors.

7. The liquid crystal display apparatus as recited in claim 5, wherein said light source includes a cold cathode fluorescent lamp.

8. The liquid crystal display apparatus as recited in any one of claims 3 to 7, further including operation means for comparing a signal level detected by said optical sensor unit with a reference level to generate control information, and backlight control means for controlling an intensity of said light source based on the control information from said operation means.

9. The liquid crystal display apparatus as recited in any one of claims 3 to 7, further including operation means for comparing a signal level detected by said optical sensor unit with a reference level to generate control information, and backlight control means for controlling an intensity of said light source based on the control information from said operation means, said liquid crystal display apparatus being controlled by a field sequential color method.
